(19) United States
(12) Patent Application Publication
(10) Pub. No.: US 2025/0196751 A1
(43) Pub. Date: Jun. 19, 2025

(54) Trolley System For Cargo Vehicles

(71) Applicant: MORGAN OLSON LLC, Sturgis, MI (US)

(72) Inventors: John Monnin, Granger, IN (US); Ellen Dzierzyc, Kalamazoo, MI (US)

(21) Appl. No.: 18/980,326

(22) Filed: Dec. 13, 2024

Related U.S. Application Data
(60) Provisional application No. 63/609,425, filed on Dec. 13, 2023.

(51) Int. Cl. B60P 1/54

(52) U.S. Cl. CPC B60P 1/5495

(57) ABSTRACT

A trolley system for use in a cargo area of a vehicle, including an elongated main rail having a first end and a second end adjacent to an access opening of the cargo area. A swing arm assembly has an elongated top rail pivotably mounted adjacent the second end of the main rail. The swing arm assembly is pivotable between a first position in which the first end of the top rail is disposed inside the cargo area and a second position in which the first end of the top rail extends outwardly through the access opening so that the longitudinal axis of the top rail is collinear with the longitudinal axis of the main rail.

### CROSS-REFERENCE TO RELATED APPLICATIONS

This application claims priority to and the benefit of the filing date of U.S. Provisional Patent Application No. 63/609,425, filed Dec. 13, 2023, the entirety of which is hereby incorporated by reference herein in its entirety.

### FIELD

This application relates to vehicles (e.g., cargo and/or delivery vehicles) and, in particular, to trolley systems and methods of use thereof to facilitate the delivery of large amounts of laundry from within a vehicle.

### BACKGROUND

Commercial entities that transport large volumes of soiled laundry such as, but not limited to, uniforms, tablecloths, towels, etc., often collect the soiled laundry in cargo vehicles, such as walk-in vans. The collection and distribution of the laundry is most often performed by the driver of the cargo vehicle. For example, soiled laundry is typically collected at one or more customer sites in cargo bags that are then transported to the central laundering location. Upon arrival, the driver manually unloads cargo bags (containing the laundry) from the cargo area of the vehicle by hand. As would be expected, individual cargo bags of laundry can be heavy, unwieldy, and difficult to handle. The strenuous nature of unloading the cargo bags means injuries are to be expected, leading to a loss of man-hours, increased labor costs, and overall inefficiency.

From the above, it can be appreciated that improved systems and methods for unloading cargo from vehicles are desirable.

### SUMMARY

Disclosed herein, in one aspect, is a trolley system for use in a cargo area of a vehicle (e.g., a delivery vehicle). The trolley system may include an elongated main rail secured to a side wall of the cargo area, the main rail having a longitudinal axis and including a first end disposed inside the cargo area and a second end adjacent to the an access opening of the cargo area. The system may also include a swing arm assembly having an elongated top rail pivotably mounted to the side wall of the cargo area adjacent the second end of the main rail. The swing arm assembly is pivotable between a first position in which the first end of the top rail of the swing arm assembly is disposed inside the cargo area and a longitudinal axis of the top rail is extending alongside and spaced apart from the longitudinal axis of the main rail, and a second position in which the first end of the top rail extends outwardly through the access opening so that the first end of the top rail is disposed outside of the cargo area and the longitudinal axis of the top rail is collinear with or parallel or substantially parallel to the longitudinal axis of the main rail. In the second position, cargo inside the cargo area may be slid continuously along the main rail and onto the top rail of the swing arm assembly until the cargo is outside of the cargo area.

In another embodiment, a trolley system for use in a cargo area of a vehicle may include an elongated main rail having a first end and a second end, the main rail being mounted to a side wall of the cargo area. The system may include a cargo bag assembly having a carrier and a cargo bag extending downwardly therefrom, the carrier being slidably supported on the main rail. A first end of the main rail is disposed inside the cargo area of the vehicle, and the second end of the main rail is movable from a first position in which the second end of the main rail is disposed inside the cargo area to a second position in which the second end of the main rail both extends outwardly through the access opening of the cargo area and is disposed outside the cargo area. As such, cargo may be slid along the main rail from inside the cargo area to outside the cargo area.

Additional advantages of the disclosed system and method will be set forth in part in the description which follows, and in part will be understood from the description, or may be learned by practice of the disclosed system and method. The advantages of the disclosed system and method will be realized and attained by means of the elements and combinations particularly pointed out in the appended claims. It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the disclosed apparatus, system, and method and together with the description, serve to explain the principles of the disclosed apparatus, system, and method.

FIG. 1 is a side plan view of a side wall of a cargo area of a vehicle including a cargo trolley system in accordance with an embodiment of the present invention as disclosed herein;

FIG. 2 shows a close-up side plan view of the cargo trolley system shown in FIG. 1;

FIG. 3 shows a close-up perspective view of the cargo trolley system shown in FIG. 1, with the swing arm assembly in the stowed position;

FIG. 4 shows a close-up view of the cargo trolley system shown in FIG. 3 with the swing arm assembly in the cargo delivery position;

FIG. 5 shows a perspective view of the cargo area and trolley system shown in FIG. 1 with a user unloading cargo from the cargo area or the trolley system;

FIG. 6 shows a perspective view of the cargo area and trolley system shown in FIG. 5 with the cargo disposed outside of the cargo area of the vehicle;

FIG. 7 shows a close-up perspective view of a cargo trolley system in accordance with an alternate embodiment of the present invention, with the swing arm assembly in the stowed position;

FIG. 8 shows a close-up view of the cargo trolley system shown in with the swing arm assembly in the cargo delivery position;

FIG. 9 is a schematic drawing of a vehicle having a cargo trolley system in accordance with an embodiment of the present invention as disclosed herein; and

FIG. 10 is a schematic drawing of the vehicle of FIG. 9, with a second portion of a main rail of the cargo trolley system in an extended position.

### DETAILED DESCRIPTION

The disclosed system and method may be understood more readily by reference to the following detailed description of particular embodiments and the examples included therein and to the Figures and their previous and following description.

It is to be understood that the terminology used herein is for the purpose of describing particular embodiments only and is not intended to limit the scope of the present invention which will be limited only by the appended claims.

It must be noted that as used herein and in the appended claims, the singular forms “a,” “an,” and “the” can include plural references unless the context clearly dictates otherwise. Thus, for example, reference to a “wheel assembly” amounts to a disclosure of embodiments in which only a single wheel assembly is provided, as well as embodiments in which a plurality of such wheel assemblies are provided.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Optionally, in some aspects, when values or characteristics are approximated by use of the antecedents “about,” “substantially,” or “generally,” it is contemplated that values within up to 15%, up to 10%, up to 5%, or up to 1% (above or below) of the particularly stated value or characteristic can be included within the scope of those aspects.

Optionally, in some aspects, the term “adjacent to” can refer to within 5 feet, or within 4 feet, or within 3 feet, or within 2 feet, or within 1 foot. More generally, the term “adjacent to” can be understood by one skilled in the art based on context to achieve the desired result, such as, in one example consistent with the present disclosure, permitting the end of the swing arm to extend to a location exterior to a rear opening of a vehicle.

Unless defined otherwise, all technical and scientific terms used herein have the same meanings as commonly understood by one of skill in the art to which the disclosed apparatus, system, and method belong. Although any apparatus, systems, and methods and materials similar or equivalent to those described herein can be used in the practice or testing of the present apparatus, system, and method, the particularly useful methods, devices, systems, and materials are as described.

Throughout the description and claims of this specification, the word “comprise” and variations of the word, such as “comprising” and “comprises,” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

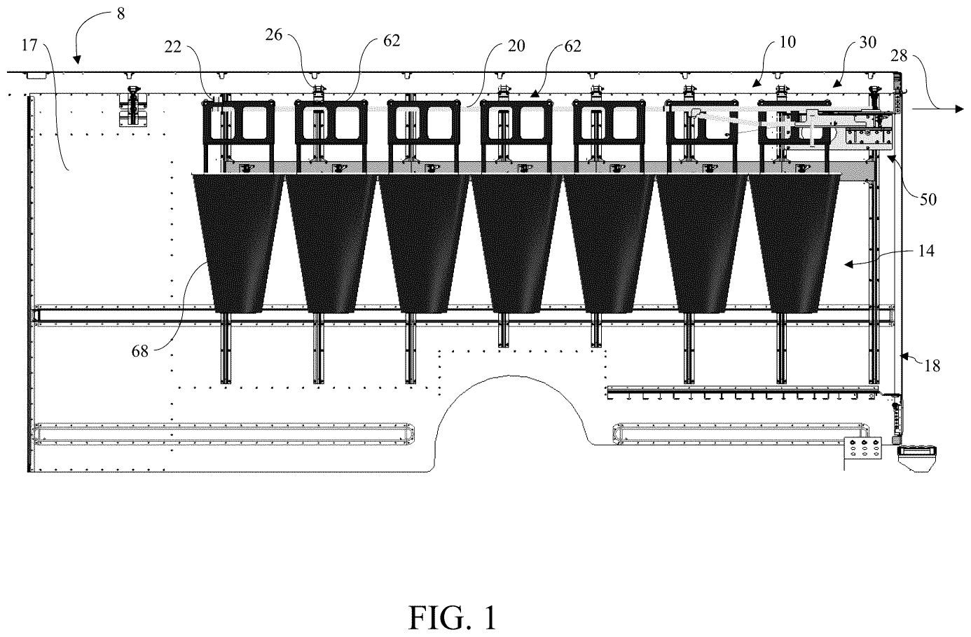

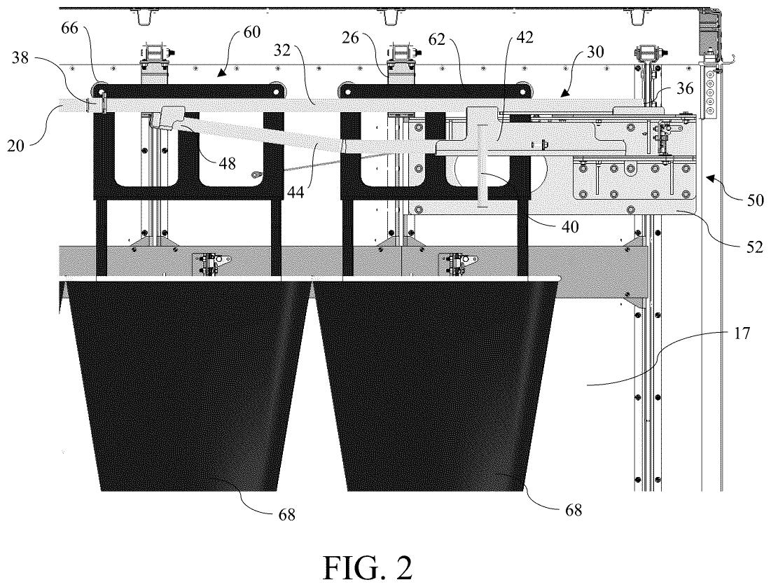

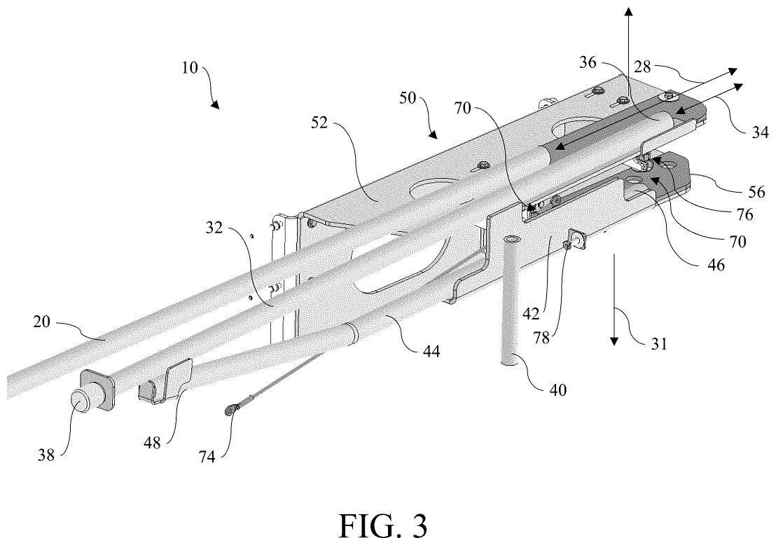

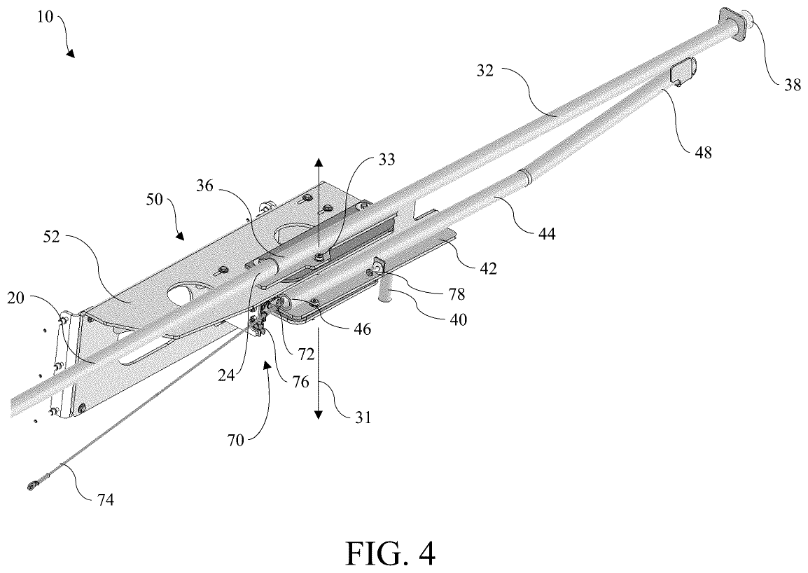

Referring now to the figures, a trolley system 10 for use in the cargo area of a vehicle 8 is shown in FIGS. 1 and 2. In exemplary aspects, the vehicle 8 can be a delivery vehicle or a cargo vehicle as are known in the art. The trolley system 10 is preferably secured to a side wall 17 in the cargo area 14 of the vehicle 8 and includes an elongated main rail 20, a swing arm assembly 30. As shown, the main rail 20 is mounted to the side wall 17 of the cargo area 14 by a plurality of brackets 26 spaced along its length. Optionally, the main rail 20 is substantially cylindrical; however, it is contemplated that other profiles of the main rail can be used. The main rail 20 includes a first end 22 that is disposed toward the cab of the vehicle and a second end 24 that is mounted adjacent the access opening 18 of the vehicle's cargo area 14. Referring additionally to FIGS. 3 and 4, the second end 24 of the main rail 20 is mounted to the side wall 17 by mounting assembly 50. The mounting assembly 50 includes a body portion 52 that is in securely coupled to (e.g., in direct contact with) the side wall 17 and is used to pivotably mount the swing arm assembly 30 to the side wall 17 as well.

As best seen in FIGS. 3 and 4, the swing arm assembly 30 includes an elongated top rail 32 having a first end 36 that is pivotably mounted to, or adjacent to, the body portion 52 of the mounting assembly 50, and a second end 38 that may be pivoted from a first position (FIG. 3) inside the cargo area 14 to a second position (FIG. 4) in which the second end 38 is disposed outside the cargo area 14. As shown, a swing arm assembly 30 also includes a bottom rail 44 that acts as a brace to support the top rail 32. The bottom rail 44 can include a first end 46 that is secured to a support plate 42 of the swing arm assembly 30 and a second end 48 that is secured to the top rail 32 at or adjacent to its second end 38. The swing arm assembly 30 is pivotably mounted to the body portion 52 of the mounting assembly 50 by a pivot joint 33 (e.g., a pair fasteners) that lie along a vertical pivot axis 31. The swing arm assembly 30 includes a rotation stop 40. For example, the rotation stop 40 can be or comprise a vertical post that extends downwardly from the support plate 42 and is configured to abut a stop surface 56 formed on the body portion 52 of the mounting assembly when the top rail 32 of the swing arm assembly 30 is axially aligned with the main rail 20 of the trolley system 10, as shown in FIG. 4.

Referring again to FIG. 2, the trolley system 10 also includes one or more cargo bag assemblies 60 that are slidably supported by the main rail 20 of the trolley system 10. In the embodiment shown, each cargo bag assembly 60 includes a carrier 62 that includes a plurality of rollers 66 mounted thereon that are configured to rollably engage the main rail 20. A cargo bag 68 is supported from the frame of a corresponding carrier 62 and is configured to receive soiled laundry and linens therein. Preferably, the bottom of each cargo bag 68 may be selectively opened so that the soiled laundry and linens stored therein may be dropped out of the cargo bag without removing the cargo bag assembly 60 from the trolley system 10.

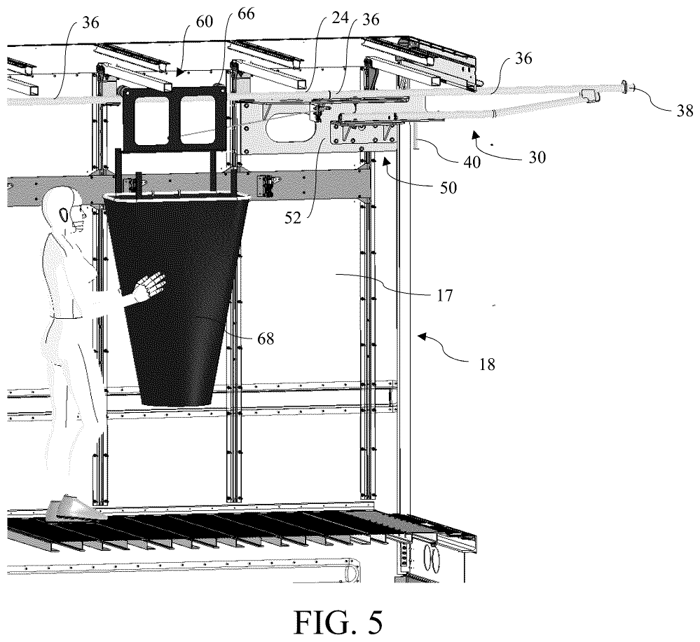

In use, the swing arm assembly 30 of the trolley system 10 is initially in the stowed position shown in FIG. 3 in which a longitudinal axis 34 of the top rail 32 of the swing arm assembly 30 is alongside (e.g., substantially parallel to) and spaced from the longitudinal center axis 28 of the main rail 20. To unload the cargo bag assemblies 60, the user pivots the swing arm assembly 30 outwardly about pivot axis 31 so that the second end 38 is disposed outside of the cargo area 14 as shown in FIG. 5. Rotation of the swing arm assembly 30 continues until the rotation stop 40 comes into abutment with the stop surface 56 on the mounting assembly 50. At this point, the longitudinal axis 34 of the top rail 32 of the swing arm assembly 30 is collinear or substantially collinear (e.g., within 10 degrees of being collinear) with the longitudinal axis 28 of the main rail 20. In use, it is contemplated that when the top rail 32 and the main rail 20 are collinear or substantially collinear, the longitudinal axes of the two rails can be sufficiently aligned or parallel (and optionally spaced) to permit continuous travel of a carrier of a cargo bag assembly between said two rails.

In some aspects, the trolley system 10 can comprise at least one latch 70. For example, the trolley system can define a pair of latches 70, wherein a first latch of the pair of latches is configured to retain the swing arm assembly 30 in the first position, and a second latch of the pair of latches is configured to retain the swing arm assembly 30 in the first position. For example, each latch 70 can comprise a keeper 76 or catch structure that is configured to engage a respective feature 78 (e.g., a striker bolt) extending from the swing arm assembly 30 when the swing arm assembly is in a respective one of the first or second positions. Accordingly, in some aspects, a feature 78 can extend from each side of the swing arm assembly 30. The latch can further comprise a lever 72 that actuates the keeper 76 to disengage the keeper from the feature 78. The keeper 76 can be spring-biased to retain the feature 78. A lanyard 74 can couple to the lever 72 to permit actuation of the keeper.

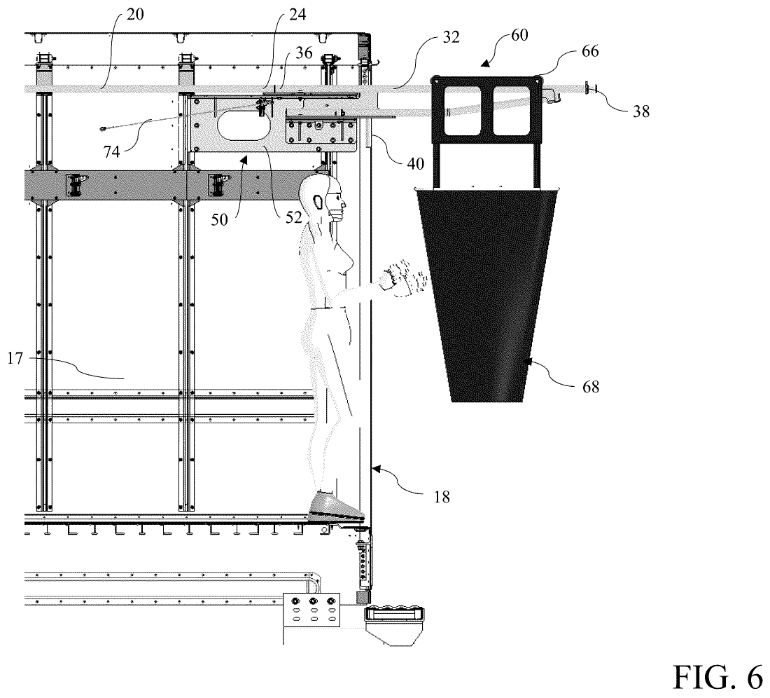

With the top rail 32 of the swing arm assembly 30 aligned with the main rail 20, the user may push the loaded cargo bag assembly 60 out of the cargo area 14 as the rollers 66 of each cargo bag assembly 60 move along both the main rail 20 and the top rail 32. Once the cargo bag assembly 60 is disposed outside of the vehicle, as shown in FIG. 6, the user may open the bottom of the cargo bag 68 so that the soiled linens and laundry may be dropped into a corresponding bin (not shown) disposed beneath the cargo bag assembly 60. After the soiled linens and laundry have been delivered, the empty and now light (decreased weight) cargo bag assembly 60 may be removed from the top rail 32 of the swing arm assembly 30 and moved back to the first end 22 of the main rail 20 inside the cargo area 14. As such, subsequent full cargo bag assemblies 60 may be rolled outwardly along the trolley system and unloaded. After the final cargo bag assembly 60 has been emptied, the user pulls downwardly on the lanyard 74 of the latch assembly, causing the plunger 72 to pivot against the spring-bias thereby releasing the feature 78 of the swing arm assembly 30. The user may now rotate the swing arm assembly 30 back into the stowed position, as shown in FIG. 4.

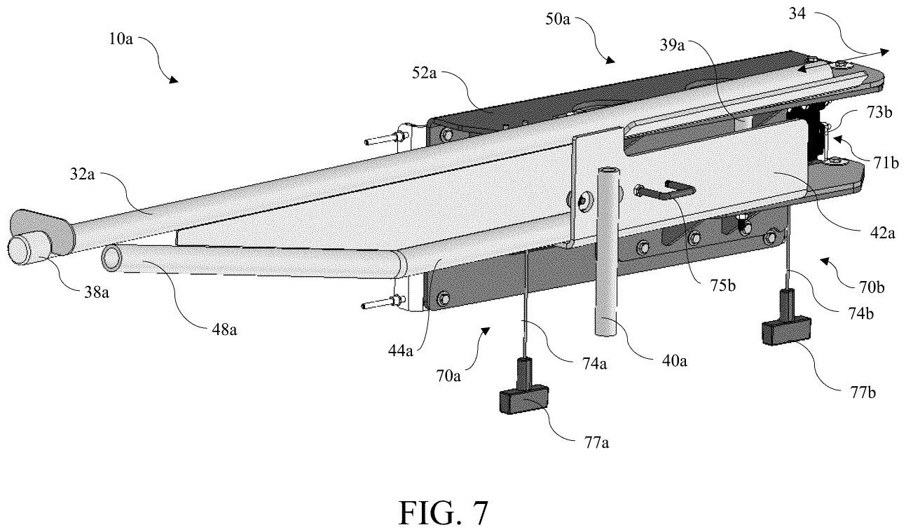

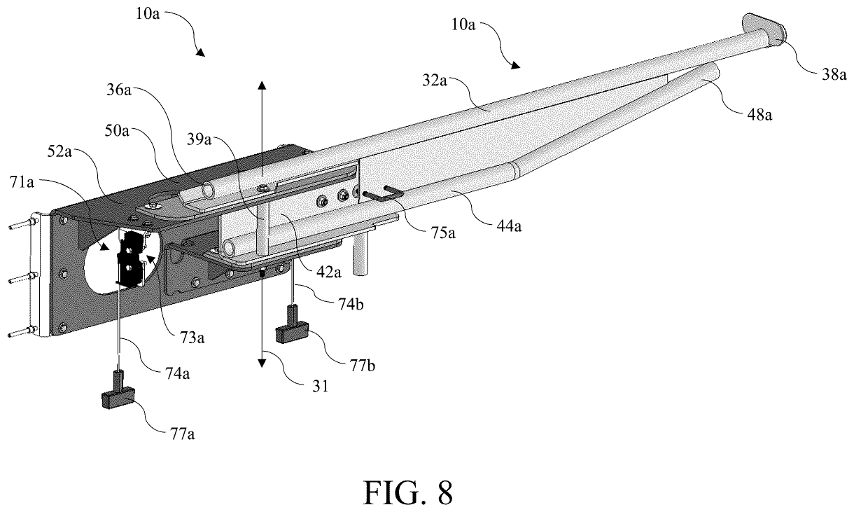

Referring now to FIGS. 7 and 8, a trolley system 10a in accordance with an alternate embodiment of the present invention is shown. As with the previously discussed embodiment, the trolley system 10a can be secured to a side wall 17 in the cargo area 14 of a vehicle and includes a swing arm assembly 30a and a pair of latch assemblies 70a and 70b. The swing arm assembly 30a includes an elongated top rail 32a having a first end 36a that is pivotably mounted to, or adjacent to, the body portion 52a of the mounting assembly 50a, and a second end 38a that may be pivoted from a first position (FIG. 7) inside the cargo area of the vehicle to a second position (FIG. 8) in which the second end 38a is disposed outside the cargo area of the vehicle. As shown, a swing arm assembly 30a also includes a bottom rail 44a that acts as a brace to support the top rail 32a. The bottom rail 44a can include a first end 46a that is secured to a support plate 42a of the swing arm assembly 30a and a second end 48a that is secured to the top rail 32a at or adjacent its second end 38a. The swing arm assembly 30a is pivotably mounted to the body portion 52a of the mounting assembly 50a by a vertical axle 39a that lies along a vertical pivot axis 31. The swing arm assembly 30a includes a rotation stop 40a. For example, the rotation stop 40a can be or comprise a vertical post that extends downwardly from the support plate 42a and is configured to abut a stop surface on the body portion 52a of the mounting assembly when the top rail 32a of the swing arm assembly 30a is axially aligned with the main rail 20 (FIGS. 1 and 2) of the trolley system 10a.

In use, the swing arm assembly 30a of the trolley system 10a is initially in the stowed position shown in FIG. 7 in which a longitudinal axis 34 of the top rail 32a of the swing arm assembly 30a is substantially parallel to and spaced from the longitudinal center axis 28 of the main rail 20 (FIG. 1). The swing arm assembly 30a is maintained in the stowed position by the first latch assembly 70a. The first latch assembly 70a includes a striker bolt 70a that is selectively engaged by a spring-operated keeper 73a. To unload the cargo bag assemblies 60 (FIG. 1), the user first releases the swing arm assembly 30a by pulling downwardly on the lanyard 74a with the handle 77a. The user now pivots the swing arm assembly 30a outwardly about pivot axis 31 so that the second end 38a is disposed outside of the cargo area 14, as shown in FIG. 5. Rotation of the swing arm assembly 30a continues until the rotation stop 40a comes into abutment with the stop surface 56 on the mounting assembly 50a. At this point, the longitudinal axis 34 of the top rail 32a of the swing arm assembly 30a is collinear with or parallel or substantially parallel (e.g., within 10 degrees of parallel) to the longitudinal axis 28 of the main rail 20. Additionally, when the swing arm assembly 30a is in the extended position, a second latch assembly 70b maintains the swing arm assembly 30a in the aligned position. Specifically, the second latch assembly 70b includes a latch body 71b having a spring-activated keeper 73b secured to the mounting plate 50a, and a striker bolt 75b mounted to the outer surface of the support plate 42a. When in the extended position, the striker bolt 75b is retained in the latch body 71b by the keeper 73b. After the final cargo bag assembly 60 has been emptied, the user pulls downwardly on the handle 77b at the bottom of the lanyard 74b of the latch assembly 70b, causing the keeper 72b to pivot against spring pressure, thereby releasing the striker bolt 75b. The user may now rotate the swing arm assembly 30a back into the stowed position, as shown in FIG. 7. The first latch assembly 70a, that operators in the same manner as the second latch assembly 70b, maintains the swing arm assembly 30a in the stowed position, as shown in FIG. 8.

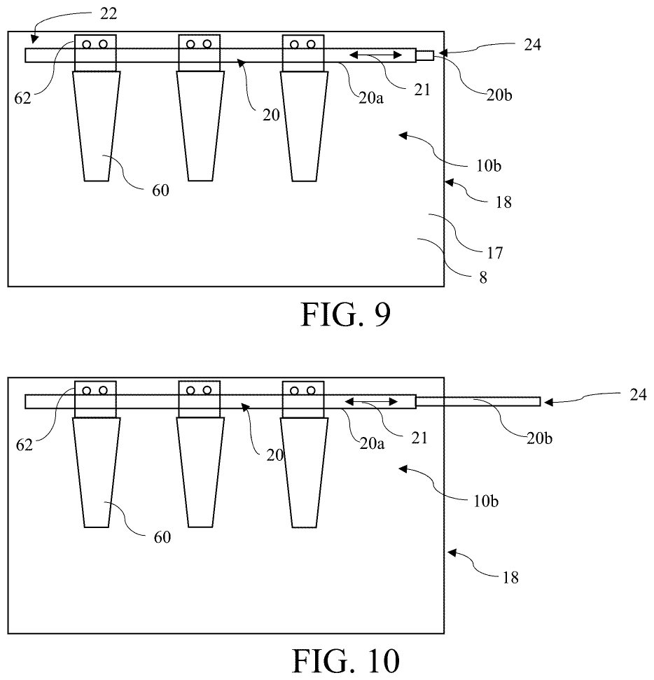

Referring to FIGS. 9-10, in additional aspects, a trolley system 10b can comprise a telescoping main rail 20 that is to be extendable outwardly from the cargo area of the vehicle 8 through the access opening 18. For example, the main rail 20 can comprise a first rail portion 20a and a second rail portion 20b. The second rail portion 20b can be slidable with respect to the first rail portion 20a along a longitudinal axis 21 of the first rail portion.

The main rail 20 can have having a first end 22 and a second end 24. The main rail being mounted to a side wall of a cargo area of a vehicle.

The trolley system 10b can comprise one or a plurality of cargo bag assemblies 60, each cargo bag assembly including a carrier 62 and a cargo bag 68 extending downwardly therefrom. The carrier 62 can be slidably supported on the main rail 20. The first end 22 of the main rail is disposed inside the cargo area of the vehicle. The second end of the main rail can be movable from a first position in which the second end of the main rail is disposed inside the cargo area to a second position in which the second end of the main rail both extends outwardly through the access opening of the cargo area and is disposed outside the cargo area.

Optionally, in exemplary aspects, the first rail portion and the second rail portion of the main rail can be cylindrical or rectangular in shape.

Those skilled in the art will recognize, or be able to ascertain using no more than routine experimentation, many equivalents to the specific embodiments of the method and compositions described herein. Such equivalents are intended to be encompassed by the following claims.

What is claimed is:

1. A trolley system for use in a cargo area of a vehicle, comprising:
an elongated main rail secured to a side wall of the cargo area, the main rail having a longitudinal axis and including a first end disposed inside the cargo area and a second end adjacent to the an access opening of the cargo area; and
a swing arm assembly including an elongated top rail pivotably mounted to the side wall of the cargo area adjacent to the second end of the main rail, the top rail having a first end and a longitudinal axis,
wherein the swing arm assembly is pivotable between a first position in which the first end of the top rail of the swing arm assembly is disposed inside the cargo area and the longitudinal axis of the top rail is extending alongside and spaced apart from the longitudinal axis of the main rail, and a second position in which the first end of the top rail extends outwardly through the access opening so that the first end of the top rail is disposed outside of the cargo area and the longitudinal axis of the top rail is collinear with or parallel or substantially parallel to the longitudinal axis of the main rail.

2. The trolley system of claim 1, further comprising a cargo bag assembly including a carrier that is slidably supported on the main rail, and a cargo bag extending downwardly from the carrier, wherein the carrier is configured for motion axially along both the main rail and the top rail.

3. The trolley system of claim 2, wherein the carrier comprises a frame and a plurality of rollers, wherein the plurality of rollers is secured to the frame and each roller of the plurality of roller is in rolling contact with the main rail.

4. The trolley system of claim 3, wherein the main rail and the top rail are cylindrical in shape.

5. The trolley system of claim 3, wherein the main rail and the top rail are rectangular in cross-sectional shape.

6. The trolley system of claim 2, further comprising a mounting assembly including a body portion that is secured to the side wall of the vehicle adjacent the access opening of the cargo area, wherein the second end of the main rail is secured to the body portion of the mounting assembly, and the swing arm assembly is mounted to the body portion of the mounting assembly at a pivot joint having a pivot axis that is perpendicular to the longitudinal axis of the main rail.

7. The trolley system of claim 6, further comprising a rotation stop that includes a projection disposed on the swing arm assembly and a stop surface disposed on the body portion of the mounting assembly, wherein the projection abuts the stop surface when the swing arm assembly is in the second position.

8. The trolley system of claim 1, further comprising a latch that is movable between a locked position and an unlocked position, wherein in the locked position the latch engages the swing arm assembly and prevents rotation of the top rail from the second position.

9. The trolley system of claim 8, wherein the swing arm assembly is pivotable from the second position to the first position when the latch is in the unlocked position.

10. A trolley system for use in a cargo area of a vehicle, the cargo area having an access opening, the trolley system comprising:
an elongated main rail having a first end and a second end, the main rail being mounted to a side wall of the cargo area; and
a cargo bag assembly including a carrier and a cargo bag extending downwardly therefrom, the carrier being slidably supported on the main rail,
wherein the first end of the main rail is disposed inside the cargo area of the vehicle, and
wherein the second end of the main rail is movable from a first position in which the second end of the main rail is disposed inside the cargo area to a second position in which the second end of the main rail both extends outwardly through the access opening of the cargo area and is disposed outside the cargo area.

11. The trolley system of claim 10, wherein the main rail comprises a first rail portion and a second rail portion, wherein the second rail portion is slidable with respect to the first rail portion along a longitudinal axis of the first rail portion.

12. The trolley system of claim 11, where the carrier is configured for motion axially along both the first rail portion and the second rail portion of the main rail.

13. The trolley system of claim 12, wherein the carrier comprises a frame and a plurality of rollers, wherein the plurality of rollers is secured to the frame and each roller of the plurality of roller is in rolling contact with the main rail.

14. The trolley system of claim 13, wherein the first rail portion and the second rail portion of the main rail are cylindrical in shape.

15. The trolley system of claim 10, wherein the main rail further comprises a first rail portion fixed to the side wall of the cargo area and a second rail portion pivotably mounted to the side wall of the cargo area, wherein each of the first and second rail portions has a respective longitudinal axis.

16. The trolley system of claim 15, wherein the second end of the main rail is disposed on the second rail portion, and the second rail portion is pivotable between a first position in which the second end of the main rail is disposed inside the cargo area and the longitudinal axis of the second rail portion is both parallel to and spaced apart from the longitudinal axis of the first rail portion, and a second position in which the second end of the main rail is disposed outside of the cargo area and the longitudinal axis of the second rail portion is collinear with or parallel or substantially parallel to the longitudinal axis of the first rail portion.

17. The trolley system of claim 16, further comprising a latch including a latch that is movable between a locked position and an unlocked position, wherein in the locked position the latch engages the second rail portion and prevents rotation of the second rail portion from the second position.

18. The trolley system of claim 17, wherein the second rail portion is pivotable from the second position to the first position when the latch is in the unlocked position.

19. A vehicle comprising:
a cargo area having an access opening; and
a trolley system disposed in the cargo area, the trolley system comprising:
an elongated main rail secured to a side wall of the cargo area, the main rail having a longitudinal axis and including a first end disposed inside the cargo area and a second end adjacent the access opening of the cargo area; and
a swing arm assembly including an elongated top rail pivotably mounted to the side wall of the cargo area adjacent the second end of the main rail, the top rail having a longitudinal axis,
wherein the swing arm assembly is pivotable between a first position in which a first end of the top rail of the swing arm assembly is disposed inside the cargo area and the longitudinal axis of the top rail is both parallel to and spaced apart from the longitudinal axis of the main rail, and a second position in which the first end of the top rail extends outwardly through the access opening so that the first end of the top rail is disposed outside of the cargo area and the longitudinal axis of the top rail is collinear with or parallel or substantially parallel to the longitudinal axis of the main rail.

20. The vehicle claim 19, further comprising a cargo bag assembly including a carrier that is slidably supported on the main rail, and a cargo bag extending downwardly from the carrier, wherein the carrier is configured for motion axially along both the main rail and the top rail.
